(19) United States
(12) Patent Application Publication
(10) Pub. No.: US 2009/0013058 A1
(43) Pub. Date: Jan. 8, 2009

(54) Embedded device and method for assisting in processing media content based on subcribed syndication feed

(75) Inventor: Chien-Di Chan, Taipei City (TW)

Correspondence Address: BIRCH STEWART KOLASCH & BIRCH, PO BOX 747, FALLS CHURCH, VA, 22040-0747, US

(73) Assignee: Meng-Gung, Li

(21) Appl. No.: 12/000,988

(22) Filed: Dec. 19, 2007

(30) Foreign Application Priority Data
Jul. 6, 2007 (TW) 096124708

(51) Int. Cl. G06F 15/16

(52) U.S. Cl. 709/217

(57) ABSTRACT

The invention provides a device, embedded in an electronic equipment, for assisting in processing a media content based on a subscribed syndication feed. The invention utilizes a widget engine module to perform a widget application to parse the subscribed syndication feed to obtain link tags, to download media data based on the link tags, and to generate the media content based on the parsed subscribed syndication feed, the media data and a user interface provided by the widget engine module. Thereby, a user can use the electronic equipment to, over the internet, subscribe and download information of interest, shared media content or other specific services or tools.

### BACKGROUND OF THE INVENTION

1. Field of the Invention

The invention relates to an embedded device and more particularly, to an embedded device for assisting in processing a media content based on a subscribed syndication feed.

2. Description of the Prior Art

Syndication feeds, such as RSS feeds, ATOM feeds and so on, are popular web sharing tool for the time being. Web users can, by subscribing relative feeds, access updated information of web sites of interest without browsing them. Partial web servers also allow users to use the syndication feeds for downloading relative multimedia contents to achieve various applications such as stock quote information, online photo management, real-time news, music sharing management, digital TV programs, and the like.

Innovative electronic equipments such as optical information reproducing apparatuses, digital television receivers, digital photo frames, portable media players, potable computers, personal digital assistants, and mobile communication apparatuses, and so on, are getting more popular. If they are equipped with network communication functions, users can access multimedia content in any place of the building, including living room, kitchen, bed room, and the like.

However, since the electronic equipments mentioned above can not subscribe and download the syndication feeds over the open network, they can not download the related multimedia content. As a result, the applications of the electronic equipments become very limited.

Accordingly, a main scope of the invention is to provide an embedded device and method to solve above problem.

### SUMMARY OF THE INVENTION

A scope of the invention is to provide an embedded device and method for assisting in processing a media content based on a subscribed syndication feed. The embedded device utilizes a widget engine module to perform a widget application for assisting in processing the media content based on the subscribed syndication feed. Thereby, a user can use an electronic equipment with the embedded device through the subscription service management, to subscribe and download desired real-time information, shared media content or other service/tool over the internet. In addition, providers can offer users different services/tools through the network, so as to improve convenience and versatility of the electronic equipment.

According to an embodiment of the invention, a device, embedded in the electronic equipment, is used for assisting in processing a media content based on a subscribed syndication feed. The electronic equipment includes a communication module capable of establishing a communication link with a server over a network, where the server provides a plurality of syndication feeds.

The device includes a processing module and a widget engine module. The processing module is coupled to the communication module of the electronic equipment, and is used for, through the communication module, selecting and downloading one selected from the plurality of syndication feeds as the subscribed syndication feed.

The widget engine module is coupled to the processing module. The widget engine module is supported by the processing module to perform a widget application to parse the subscribed syndication feed to obtain N first link tags, to download N first media data based on the N first link tags, and to generate the media content based on the parsed subscribed syndication feed, the N first media data and a user interface provided by the widget engine module, where N is a natural number.

A method according to another embodiment of the invention is for assisting an electronic equipment in processing a media content based on a subscribed syndication feed. The electronic equipment includes a communication module capable of establishing a communication link with a server over a network, where the server provides a plurality of syndication feeds.

The method, firstly, through the communication module, selects and downloads one selected from the plurality of syndication feeds as the subscribed syndication feed. Finally, the method performs a widget application to parse the subscribed syndication feed to obtain N first link tags, to download N first media data based on the N first link tags, and to generate the media content based on the parsed subscribed syndication feed, the N first media data and a user interface, where N is a natural number.

Therefore, the embedded device and method according to the invention is for assisting in processing a media content based on a subscribed syndication feed. The embedded device uses a widget engine module to perform a widget application to assisting in processing the media content based on the subscribed syndication feed. Thereby, users can use an electronic equipment with the embedded device, through the subscription service management, to subscribe and download desired real-time information, shared media content or other service/tool over the internet. In addition, providers can offer users widget applications with life-cycle management and different services/tools through the network, so as to improve convenience and versatility of the electronic equipment.

The advantage and spirit of the invention may be understood by the following recitations together with the appended drawings.

### BRIEF DESCRIPTION OF THE APPENDED DRAWINGS

FIG. 1 shows a function block diagram of an embedded device according to an embodiment of the invention.

FIG. 2 shows a media content related to a stock quotes which the embedded device shown in FIG. 1 assists in processing.

FIG. 3A shows a media content related to My Pictures which the embedded device shown in FIG. 1 assists in processing.

FIG. 3B shows a media content related to Car Pictures which the embedded device shown in FIG. 1 assists in processing.

FIG. 4 shows a flow chart of the method according to an embodiment of the invention.

FIG. 5 shows a flow chart of the method for updating syndication feeds in a real application according to the invention.

### DETAILED DESCRIPTION OF THE INVENTION

The invention provides an embedded device and method according to the invention is for assisting in processing a media content based on a subscribed syndication feed. The embedded device uses a widget engine module to perform a widget application to assisting in processing the media content based on the subscribed syndication feed. Thereby, a user can use an electronic equipment with the embedded device, through a subscription service management, to subscribe and download desired real-time information, shared media content or other service/tool from the internet. In addition, providers can offer users different services/tools through the network, so as to improve convenience and versatility of the electronic equipment. The spirit and feature of the present invention will be described in detail by the following preferred embodiments.

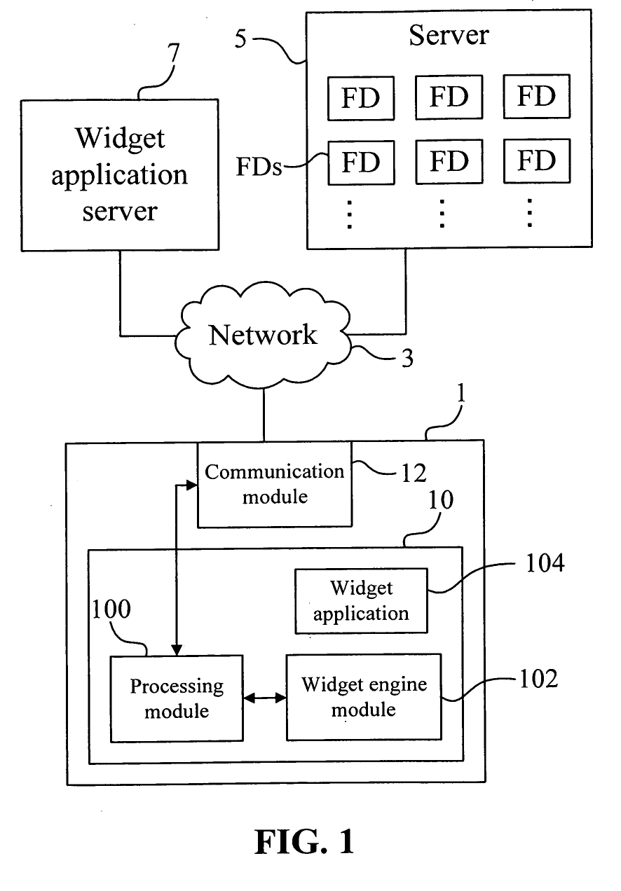

Please refer to FIG. 1. FIG. 1 shows a function block diagram of an embedded device 10 according to an embodiment of the invention. According to an embodiment of the invention, a device 10, embedded in an electronic equipment 1, is used for assisting in processing a media content based on a subscribed syndication feed. In real applications, the electronic equipment 1 can be an optical information reproducing apparatus, a digital television receiver, a digital photo frame, a portable media player, a potable computer, a personal digital assistant, a mobile communication apparatus, or the like.

As shown in FIG. 1, the electronic equipment 1 includes a communication module 12 capable of establishing a communication link with a server 5 over a network 3, where the server 5 provides a plurality of syndication feeds FD. In real applications, the network 3 can be, but not limited to, a local area network, an Internet, a radio telecommunication network, or a public switched telephone network. The server 5 can be, but not limited to, a web server in an open network.

As shown in FIG. 1, the embedded device 10 can include a processing module 100 and a widget engine module 102. The processing module 100 is coupled to the communication module 12 of the electronic equipment 1. The processing module 100 can, through the communication module 12, select and download one selected from the plurality of syndication feeds FD as the subscribed syndication feed FDs.

As shown in FIG. 1, the widget engine module 102 is coupled to the processing module 100. The widget engine module 102 is supported by the processing module 100 to perform a widget application 104 to parse the subscribed syndication feed FDs to obtain N first link tags, to download N first media data based on the N first link tags, and to generate the media content based on the parsed subscribed syndication feed FDs, the N first media data and a user interface provided by the widget engine module 102, where N is a natural number.

In real applications, each of the syndication feeds FD can be, but not limited to, an RSS feed or an ATOM feed. The widget engine module 102 can be, but not limited to, an RSS-based widget engine module or an ATOM-based widget engine module.

In real applications, the widget application 104 can be resident in the embedded device 10, or be downloaded by the processing module 100 from a widget application server 7 through the communication module 12 over the network 3. It is noticeable that the embedded device 10 can use different widget applications 104 to process media contents of different properties. For example, the embedded device 10 can use the widget application 104 for processing media content related to stock quotes to assist in processing the media content related to stock quotes. Similarly, the embedded device 10 can use the widget application 104 for processing media content related to weather forecast to assist in processing the media content related to weather forecast. In addition, providers can design the widget applications 104 based on the protocol compatible with the widget engine module 102, so as to achieve various applications such as online photo management, real-time news, music sharing management, digital TV receiving, and the like. Thereby, versatility and flexibility of the electronic equipment 1 can be improved and relative software/firmware upgrade or value-added service can be provided more conveniently. Furthermore, the providers can also offer users the widget applications 104 with life-cycle management.

In real applications, the processing module 100 can periodically send a checking request to the server 5 for checking whether the subscribed syndication feed FDs is updated, and if YES, the processing module 100 then renewedly downloads the subscribed syndication feed FDs. In other word, with the periodical checking mechanism, the users can receive the latest information conveniently.

In real applications, the subscribed syndication feed FDs can also be parsed to obtain M second link tags. The processing module 100 can download, responsive to a user input through the user interface, M second media data based on the M link tags, where M is a natural number.

In real applications, the N first media data and the M second media data both include text data, picture data, image data, audio data, video data, or the like.

In real applications, the N first link tags and the M second link tags can be hyperlinks.

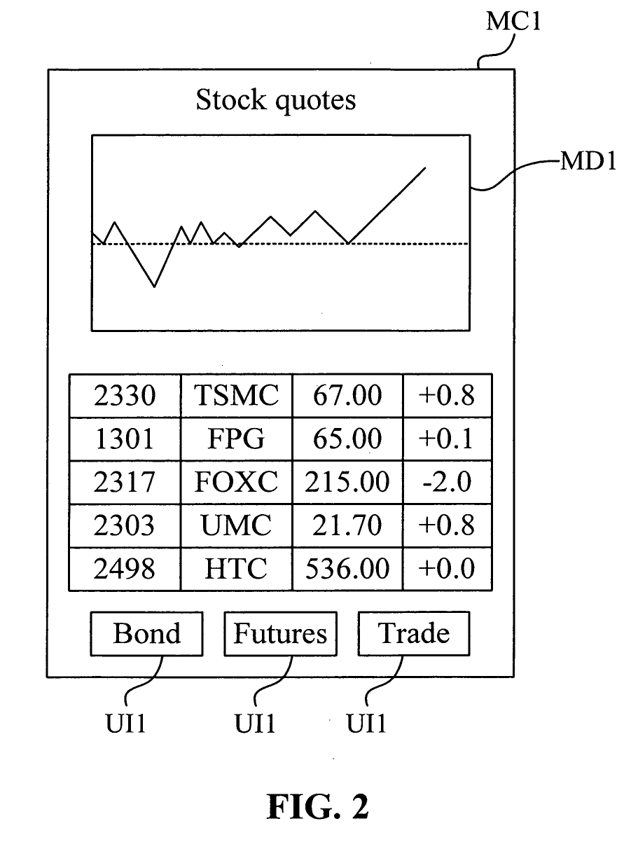

Please refer to FIG. 2. FIG.2 shows a media content related to stock quotes which the embedded device shown in FIG. 1 assists in processing. For example, a user can use the electronic equipment 1 to subscribe the subscribed syndication feed FDs relative to stock quotes. Then, when the user wants to view the stock quotes by the electronic equipment 1, the processing module 100 can select and download a subscribed syndication feed FDs relative to the stock quotes selected from the plurality of syndication feeds FD. Afterward, the widget engine module 102 is supported by the processing module 100 to perform a widget application 104 to parse the subscribed syndication feed FDs to obtain first link tags. Next, the widget engine module 102 performs the widget application 104 to download first media data MD1 based on the first link tags, where the media data MD1 is a trend map of stock quotes. Finally, the engine module 102 performs the widget application 104 to generate the media content MC1 based on the parsed subscribed syndication feed FDs, the first media data MD1 and a user interface UI1 provided by the widget engine module 102, as shown in FIG. 2. Thereby, the user can comprehend the latest stock quotes by viewing the media content MC1 relative to stock quotes.

In real applications, the processing module 100 can also periodically send a checking request to the server 5 for checking whether the subscribed syndication feed FDs is updated, and if YES, the processing module 100 then renewedly downloads the subscribed syndication feed FDs. In other words, the media content MC1 can maintain latest with the periodical checking mechanism.

In real applications, when the user input “bond” via the user interface UI1, the processing module 100 can download, responsive to the user input through the user interface UI1, second media data related to “bond”. Thereby, the user can access required information by utilizing the user interface UI1.

In real applications, the user can also use the user interface UI1 to input “Trade”, so as to activate an interactive service which allows the user to execute stock trading or other interactive operation. Thereby, the electronic equipment 1 can be more convenient and versatile.

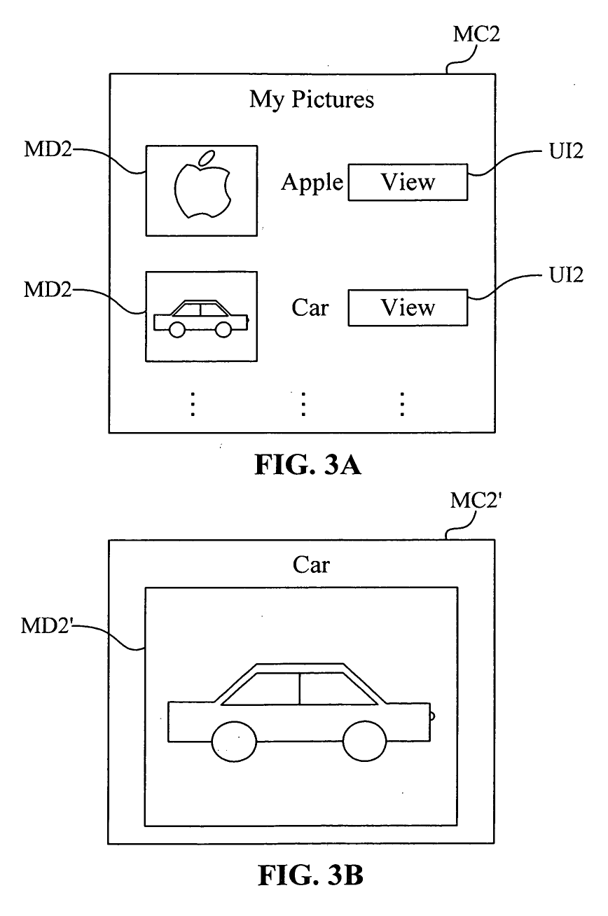

Please refer to FIG. 3A and FIG. 3B. FIG. 3A shows a media content MC2 related to “My Pictures” which the embedded device 10 shown in FIG. 1 assists in processing. FIG. 3B shows a media content MC2′ related to “Car” pictures which the embedded device 10 shown in FIG. 1 assists in processing. In another example, the electronic equipment 1 is an electronic photo frame. A user can use the electronic equipment 1 to subscribe the subscribed syndication feed FDs relative to “My Pictures”. Then, when the user wants to browse “My Pictures” by the electronic equipment 1, the processing module 100 can select and download a subscribed syndication feed FDs relative to “My Pictures” selected from the plurality of syndication feeds FD. Afterward, the widget engine module 102 is supported by the processing module 100 to perform a widget application 104 to parse the subscribed syndication feed FDs to obtain first link tags. Next, the widget engine module 102 performs the widget application 104 to download first media data MD2 based on the first link tags, where the media data MD2 are thumbnails of the pictures of “My Pictures”.

Finally, the engine module 102 performs the widget application 104 to generate the media content MC2 based on the parsed subscribed syndication feed FDs, the first media data MD2 and a user interface UI2 provided by the widget engine module 102, as shown in FIG. 3. Thereby, the user can easily browse pictures by viewing the media content MC2 relative to “My Pictures”.

In real applications, the processing module 100 can also periodically send a checking request to the server 5 for checking whether the subscribed syndication feed FDs is updated, and if YES, the processing module 100 then renewedly downloads the subscribed syndication feed FDs. In other words, the media content MC2 can remain up-to-date by the periodical checking mechanism.

In real applications, when the user input “View” via the user interface UI2 to view the picture related to “Car”, the processing module 100 can download, responsive to the user input through the user interface, second media data MD2′ related to “Car”, where the second media data MD2′ is a full-size image file related to “Car”. Finally, the embedded device 10 can therefore generate a media content MC2′. Thereby, the user can obtain the required information by utilizing the user interface UI2.

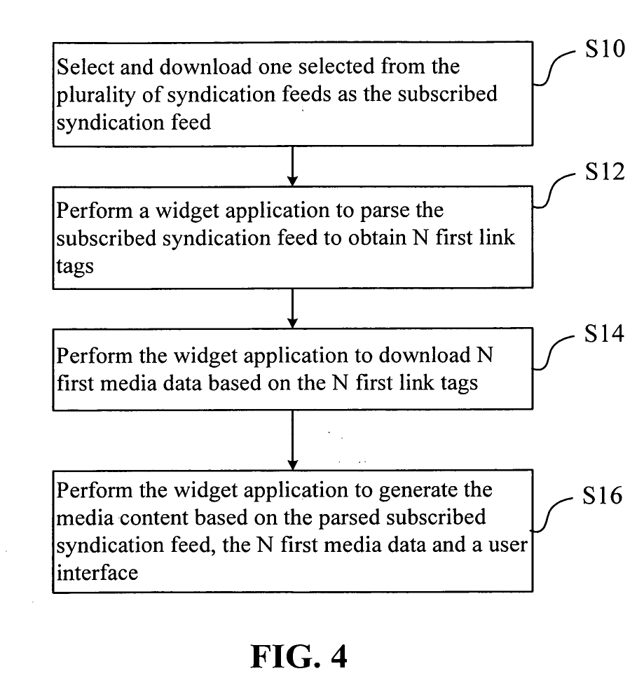

Please refer to FIG. 4 along with FIG. 1. FIG. 4 shows a flow chart of the method according to an embodiment of the invention. The method is used for assisting an electronic equipment 1 in processing a media content based on a subscribed syndication feed FDs. The electronic equipment 1 includes a communication module 12 capable of establishing a communication link with a server 5 over a network 3. And, the server 5 provides a plurality of syndication feeds FD. In real applications, the network 3 can be, but not limited to, a local area network, an Internet, a radio telecommunication network, or a public switched telephone network.

As shown in FIG. 4, the method according to an embodiment of the invention, firstly, performs step S10 to, through the communication module, select and download one selected from the plurality of syndication feeds FD as the subscribed syndication feed FDs.

Then, the method performs step S12 to perform a widget application 104 to parse the subscribed syndication feed FDs to obtain N first link tags, where N is a natural number.

Afterward, the method performs step S14 to perform the widget application 104 to download N first media data based on the N first link tags.

Finally, the method performs step S 16 to perform the widget application 104 to generate the media content based on the parsed subscribed syndication feed, the N first media data and a user interface.

In real applications, each of the syndication feeds can be, but not limited to, an RSS feed or an ATOM feed.

In real applications, the widget application 104 can be resident in the embedded device 10, or be downloaded by the processing module 100 from a widget application server 7 through the communication module 12 over the network 3. It is noticeable that the embedded device 10 can use different widget applications 104 to process media contents of different properties. For example, the embedded device 10 can use the widget application 104 for processing media content related to stock quotes to assist in processing the media content related to stock quotes. Similarly, the embedded device 10 can use the widget application 104 for processing media content related to weather forecast to assist in processing the media content related to weather forecast. In addition, providers can design the widget applications 104, so as to achieve various applications such as online photo management, real-time news, music sharing management, digital TV broadcasting, and the like. Thereby, versatility and flexibility of the electronic equipment 1 can be improved and relative software/firmware upgrade or value-added service can be provided more conveniently. Furthermore, the providers can also offer users the widget application 104 with life-cycle management.

In real applications, the subscribed syndication feed FDs can also be parsed to obtain M second link tags, where M is a natural number. The method can download, responsive to an user input through the user interface, M second media data based on the M link tags.

In real applications, the N first media data and the M second media data both can include text data, picture data, image data, audio data, video data, or the like.

In real applications, the N first link tags and the M second link tags can be hyperlinks.

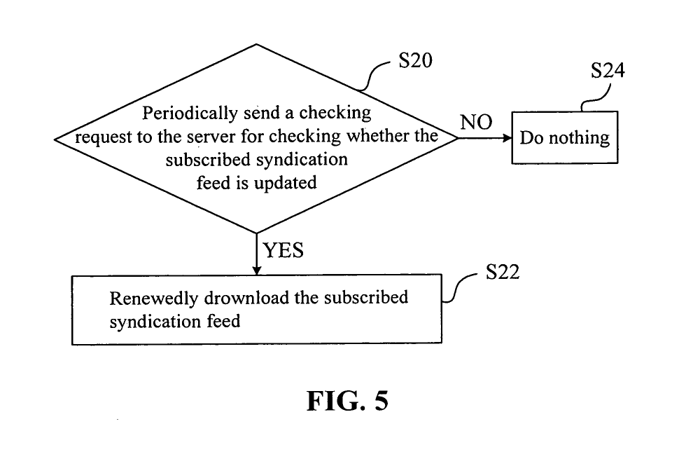

Please refer to FIG. 5. FIG. 5 shows a flow chart of method for updating syndication feeds FDs in a real application according to the invention. Ad shown in FIG. 5, the method can further perform step S20 to periodically send a checking request to the server for checking whether the subscribed syndication feed is updated. If the checking result is YES, the method performs step S22, and if the checking result is NO, the method performs step S24.

Step S22 is renewedly downloading the subscribed syndication feed FDs.

Step S24 is doing nothing. That means no renewdly downloading of the subscribed syndication feed FD is needed.

Comparing with prior arts, the embedded device and method according to the invention is for assisting in processing a media content based on a subscribed syndication feed. The embedded device utilizes a widget engine module to perform a widget application for assisting in processing the media content based on the subscribed syndication feed. Thereby, users can use an electronic equipment with the embedded device, through the subscription service management, to subscribe and download desired real-time information, shared media content or other services/tools from the internet. In addition, providers can offer users different services/tools through the network, so as to improve convenience and versatility of the electronic equipment. In addition, the providers can also offer users the widget application with life-cycle management.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A device, embedded in an electronic equipment, for assisting in processing a media content based on a subscribed syndication feed, the electronic equipment comprising a communication module capable of establishing a communication link with a server over a network, the server providing a plurality of syndication feeds, said device comprising:
a processing module, coupled to the communication module, for, through the communication module, selecting and downloading one selected from the plurality of syndication feeds as the subscribed syndication feed; and
a widget engine module, coupled to the processing module, supported by the processing module to perform a widget application to parse the subscribed syndication feed to obtain N first link tags, to download N first media data based on the N first link tags, and to generate the media content based on the parsed subscribed syndication feed, the N first media data and a user interface provided by the widget engine module, N being a natural number.

2. The device of claim 1, wherein the widget application is resident in the embedded device, or is downloaded by the processing module from a widget application server through the communication module over the network.

3. The device of claim 1, wherein the processing module also periodically sends a checking request to the server for checking whether the subscribed syndication feed is updated, and if YES, the processing module then renewedly downloads the subscribed syndication feed.

4. The device of claim 1, wherein the subscribed syndication feed is also parsed to obtain M second link tags, the processing module downloads, responsive to an user input through the user interface, M second media data based on the M link tags, M is a natural number.

5. The device of claim 1, wherein the N first media data and the M second media data both comprise one selected from the group consisting of text data, picture data, image data, audio data, and video data.

6. The device of claim 1, wherein each of the syndication feeds is an RSS feed.

7. The device of claim 6, wherein the widget engine module is an RSS-based widget engine module.

8. The device of claim 1, wherein each of the syndication feeds is an ATOM feed.

9. The device of claim 8, wherein the widget engine module is an ATOM-based widget engine module.

10. The device of claim 1, wherein the electronic equipment is one selected from the group consisting of an optical information reproducing apparatus, a digital television receiver, a digital photo frame, a portable media player, a potable computer, a personal digital assistant, and a mobile communication apparatus.

11. The device of claim 1, wherein the network is one selected from the group consisting of a local area network, an Internet, a radio telecommunication network, and a public switched telephone network.

12. A method for assisting an electronic equipment in processing a media content based on a subscribed syndication feed, the electronic equipment comprising a communication module capable of establishing a communication link with a server over a network, the server providing a plurality of syndication feeds, said method comprising the steps of:
through the communication module, selecting and downloading one selected from the plurality of syndication feeds as the subscribed syndication feed; and
performing a widget application to parse the subscribed syndication feed to obtain N first link tags, to download N first media data based on the N first link tags, and to generate the media content based on the parsed subscribed syndication feed, the N first media data and a user interface, N being a natural number.

13. The method of claim 12, wherein the widget application is residents in the electronic equipment, or is downloaded from a widget application server through the communication module over the network.

14. The method of claim 12, further comprising the step of periodically sending a checking request to the server for checking whether the subscribed syndication feed is updated, and if YES, renewedly downloading the subscribed syndication feed.

15. The method of claim 12, wherein the subscribed syndication feed is also parsed to obtain M second link tags, said method further comprises the step of downloading, responsive to an user input through the user interface, M second media data based on the M link tags, where M is a natural number.

16. The method of claim 12, wherein the N first media data and the M second media data both comprise one selected from the group consisting of text data, picture data, image data, audio data, and video data.

17. The method of claim 12, wherein each of the syndication feeds is an RSS feed.

18. The method of claim 12, wherein each of the syndication feeds is an ATOM feed.

19. The method of claim 12, wherein the electronic equipment is one selected from the group consisting of an optical information reproducing apparatus, a digital television receiver, a digital photo frame, a portable media player, a potable computer, a personal digital assistant, and a mobile communication apparatus.

20. The method of claim 12, wherein the network is one selected from the group consisting of a local area network, an Internet, a radio telecommunication network, and a public switched telephone network.
